(19) United States
(12) Patent Application Publication
(10) Pub. No.: US 2011/0086280 A1
(43) Pub. Date: Apr. 14, 2011

(54) SYSTEMS FOR THE ON-DEMAND PRODUCTION OF POWER AS A SOLE SOURCE OR AIDING OTHER POWER SOURCES, IN THE TRANSPORTATION AND HOUSING FIELD.

(76) Inventor: Alex Roustaei, Villeneuve la Garenne (FR)

(21) Appl. No.: 12/994,858

(22) PCT Filed: May 28, 2009
(86) PCT No.: PCT/FR2009/000622

§ 371 Date: Nov. 28, 2010

(30) Foreign Application Priority Data
Jun. 2, 2008 (FR) 0803019

(51) Int. Cl. H01M 8/06; C25B 9/00; C25B 1/02; C25B 15/00

(52) U.S. Cl. 429/422; 429/427; 204/242; 204/275.1; 204/230.2

(57) ABSTRACT

The system of the invention is a very efficient means for the on-demand production of hydrogen for aid, power, and electricity, operated by a control system with a modular, smart, and high-power efficiency arrangement using nanotechnology. A vast number of selections are provided for the user to obtain power production when needed or furthermore with variable delivery. Respecting cleanliness, environmental, and air pollution reduction constraints, the system is devised for use in the areas of housing, transportation, or more generally, any industry producing electricity or heat particularly by hydrocarbon means, or furthermore any environment requiring power for stationary or mobile operation.

This application is a patent application under the PCT Pub. No.: WO/2009/156610 of International Application No.: PCT/FR2009/000622, Published on Dec. 30, 2009, with International Filing Date of May 28, 2009, and domestic priority claim with the internal priority of a first application for a patent number FR08 03019, filed Jun. 2, 2008. The entire application PCT/FR2009/000622 as well as FR08 03019 are restructured and incorporated into this new application for patent by cross-referencing.

### INTRODUCTION

Historically, hydrogen has been needed for the industrial production of plastics, polymers, chemicals, pharmaceuticals and raw materials. Hydrogen is also required as additive in fertilizers for agricultural and other industrial applications. Currently the R&D projects aim specifically at hydrogen production with low cost using electrolysis for the purpose of a hybrid solutions (electric/fuel, fuel cells) and substantial reduction in NOx emissions, especially in standard combustion engines.

Meanwhile, awareness of pollution caused by transport leads to a progressive hardening of emission regulations and also the quality of fuels.

Given the urgency of the situation, to replace oil in the medium term, we need solutions from already validated for the production of hydrogen and have compatible sources in the medium and short term.

Firstly, hydrogen exists in very small quantities on Earth. For this reason, it is necessary to produce hydrogen from; for example water (electrolysis) or any hydrogenated chains such as alcohols, natural gas or fuel (the reforming reaction).

Our research for a clean, efficient, low cost energy, has led us to seek a means of converting water into energy with zero emissions of harmful gases.

Knowing that hydrogen changes the dynamics of combustion of fuel by increasing the adiabatic efficiency of the combustion cycle engine, one can introduce hydrogen into an engine that uses a hydrocarbon. This alternative is burning faster, burns cleaner and requires less fuel to run the same job.

Furthermore, hydrogen can replace oil as an energy carrier for transportation. The technology is already in a state of demonstration for road transport.

An appropriate solution to the challenges of climate change and depletion of fossil fuels leads to the use of a source of cleaner energy in better conditions, with suitable options to best to equip our transportation and our means of producing electricity and heat in habitats within the constraints related to environmental protection.

### TECHNICAL FIELD OF THE INVENTION

The present invention provides an efficient and innovative solution to produce energy and hydrogen for assistance from the abundant natural resources and available to mankind. This is a technique for producing hydrogen by electrolysis system provides super-efficient solution to the problems associated with the cell technology that is, the heat, power consumption, energy efficiency and maintenance related to permanent storage in the electrolytic cell with a technique for producing hydrogen (H2) and oxygen (½ O2) at rates that allow reuse of gases to sustain the cycle of electrolysis and beyond for additional steps which involves the production of electricity.

One of the next targets of energy production from the industrialized countries is to obtain clean, renewable resources of the planet by its use.

To this end, several techniques have been proposed and attempted to date. Among these, it was intended to make systems producing hydrogen by electrolysis systems of water and generate electricity from fuel cells. Indeed, its solutions allow both to use existing resources and to reduce pollution. Such a goal can be achieved by drawing on techniques used to date for producing hydrogen by electrolysis as described especially in patents WO/2005/047568, WO/1998/055745; WO/2000/023,638, U.S. Pat. No. 4,421,474, U.S. Pat. No. 4,081,656, U.S. Pat. No. 4,613,304, U.S. Pat. No. 4,081,656, U.S. Pat. No. 4,014,777, U.S. Pat. No. 4,081,656. Indeed, none of these inventions provides on demand production of hydrogen or electricity with an efficiency reaching 50% or more.

As a result, the achievements have been limited to experimental or specific applications. To this end, a first application was the use of electrolyzers for hydrogen production assistance for trucks, allowing them to save 10-15% fuel. However, production of hydrogen is static and has no feed-back cycle that would make the approach suitable for on demand production that would meet the demand at all engine speeds.

Meanwhile, fuel cells and hydrogen fuel cells were limited in their use because they require the use of capsules in which a limited amount of hydrogen was stored. The latter limits the scope of duties of hydrogen fuel cells for obvious reasons of autonomy and the availability of hydrogen on demand and on the fly (e.g., during a call of energy).

Again, the solution to meet this demand cannot be achieved with the techniques used so far for the production of electricity through methods such as described in Patent applications WO/2008/097798, WO/2008/097797, WO/2007/133794, WO/2007/117229, WO/2007/060369, WO/2008/105793, WO/1996/020782, WO/1997/024463.

Indeed, none of these inventions allows production of on demand and recycling of hydrogen and oxygen not consumed by their reintroduction into the chain of Water-Gas-Water which is another completely new approach in this application.

### STATE OF THE ART AND PRIOR ART

The development of hydrogen as a future energy will require a strong shift towards sustainable production and an increase in the volume of production. The main methods of hydrogen production today are based on the catalytic reforming of hydrocarbons from fossil fuels such as natural gas (methane and light alkanes) and gas derived from petroleum (LPG) or coal. These proven technologies for stationary applications require today large scale, new research efforts related to the emergence of new applications and/or constraints. This is the case of natural gas conversion into synthesis gas (CO and H2) on the extraction sites or the generation of hydrogen as fuel for fuel cell vehicle applications (e.g. electric vehicles, power supply for laptops) or domestic (e.g. Stationary electricity generators).

These applications in a short and medium term have introduced lines of research and innovative technological breakthroughs such as the miniaturization process (new technology of mini-and micro-reactors/heat exchangers, co-generating heat and electricity) or Ultra hydrogen purification before entry into the fuel cell or storage reactors.

Hydrogen production by electrolysis of water, very marginal at the global level, appears first as a non-polluting process but in fact poses the problem of the origin which is the need of the electricity. Other alternatives are also subject of active research such as using concentrated solar energy as a source of heat at high temperature and organic decomposition of water by algae and, or bacteria. Technological difficulties (solar energy) were having extremely low yields (including biological processes), however, the use of these new synthetic routes to applications, seem to be very long term marginal.

The use of hydrogen as a fuel is an additional attractive method to improve engine performance and reduce automobile emissions. A mixture of hydrogen and oxygen GEH (Hydrogen Enriched Gas=H2+O2+Steam Fuel) produced by a new type of electrolyzer was recently introduced.

We often speak of electrolysis linked to the use of renewable energy. It would be interesting if the production of electricity in this way is not truly simultaneous to the needs. The other possibility is to use electricity generated by nuclear power plants (especially during the no peak hours). The hydrogen would store electricity in chemical form and later hydrogen can be used as an energy source.

As already mentioned, the efficiency of electrolysis cannot exceed 50%, even thus in theory we can cope close to this number. But its cost is much higher than reforming because of the cost of electricity. For the process to be profitable, we need low-cost electricity. But the interesting point would be in site production or in site assistance.

Typically, the electrolytic cell consists of two electrodes (anode and cathode), an electrolyte and a current generator. We have the following reactions:
At the anode, water is dissociated into oxygen and protons. The electrons go through the circuit.
At the cathode, the protons recombine with electrons to yield hydrogen.

By applying the current, water is dissociated into hydrogen and oxygen.

It is necessary to provide electrical energy as the enthalpy of dissociation of water is 285 kJ/mole. This corresponds to a theoretical potential of 1.481 V at 25° C., but in practice, we have rather a potential between 1.7 V to 2.3 V.

The dissociation of water molecules into di-hydrogen and di-oxygen gives:

H2O→½ O2+H2 Eo=1.229 V

Overall, we 2H2O (I)→2H2 (g)+O2 (g)

Data on industrial electrolyzers provide the following information:
For a temperature of 80° C. and a pressure of 15 bar, we need about 4.5 kilowatts to produce 1 Nm3 of hydrogen (Currently, electrolyzers with an output of 1 to 100 kW are developed).
For this technology to be valid, it will be necessary to analyze both the economic but also environmental and energy on the whole life cycle, and to assess the costs of hydrogen production and the impact on the environment. These results depend largely on the type of electricity used and its cost.

Outcomes of R & D are fairly well identified.

They involve:
New materials: electrodes and catalysts in cheaper materials;
Electrolytes at higher temperature (Solid Oxide Fuel Cell-SOFC, Fuel Cell and Solid Oxide) or lower (Proton Exchange Membrane Fuel Cell, PEM Fuel cell or proton exchange membrane);
Direct use of methane as fuel, which remains an avenue to explore;
Thermal management and dynamics of the device and its behavior in real situations.

One of the major goals is lowering the cost of kW (approximately [symbol] 20 k/h today to [symbol] 0.5 or [symbol] 1 k/h).
Currently, electrolysis requires large quantity of electricity. It is also less efficient from the point of view of energetic efficiency: In fact; potential energy from produced hydrogen is only about 20% of electricity needed consumed. It is therefore relatively little used.
In fact, researchers have decreased their attention on these studies and electrolysis techniques because of all the problems most often associated with this solution that are heat and maintenance relating to deposition in the electrolytic cell. The use of different materials with a higher percentage of nickel in the construction of the electrodes did not increase the energy balance of the electrolysis technology.
Technology reverse of electrolysis of water (hydrogen fuel cell) comprising passing the hydrogen and oxygen in a catalyst for producing both water, heat and electrical current. Currently, costs remain high due to the use of precious material (platinum) in the realization of the electrodes.

### ADVANTAGES OF THE INVENTION

The present invention seeks to overcome the disadvantages of existing electrolyzers and hydrogen fuel cells and aims to provide a clean energy source capable of supplying electricity or hydrogen for the sectors of housing, transportation or industry.

According to the present invention, the power generator is characterized by the following advantages:
Use of Hydrogen oxygen gas for energy generation in a stationary and/or on-board and/or nomadic.
Assistance to the request for production of hydrogen and oxygen gases.
A system for producing hydrogen and oxygen with on the fly and variable flow, without storage and nor emitted CO2, responding to a simultaneous need for energy.
Production of hydrogen to create heat at home after conversion.
A high efficiency Production of electricity for assistance.
Production or assistance to the production of electricity with zero pollution.
Decreased cost of operations and maintenance with greater efficiency.

When hydrogen is used in a vehicle, it allows:
A reduction in emissions of greenhouse gas while improving the performance of internal combustion engine.
Increased power and life of internal combustion engines.
An innovative servo control flow of hydrogen and oxygen.
An innovative configurable for electrolytic production of hydrogen gas and oxygen separated or a stochiometric mixture.
A modular system wherein the flow is variable and adapts to the needs and the demands at a given moment.
An intermediate stage (buffer) to compensate for the inertia associated with the time constant of the system during acceleration and deceleration of the engine.

A variant of this innovation generates energy which can serve as a source of battery charging on deceleration.
This generator is also an innovative electrolysis wherein the production of hydrogen and oxygen gas is controlled by variation of current intensity (I), pulse duration (t), exposed surfaces of electrodes and number of modules.
   An amperage controller designed in the system from an external power source (conventional or renewable power source, generator, thermo electric or battery).
   A super-efficient electrolysis system with electrodes in Nano metals, a command and control devices of subjugation of ion concentration and operating temperature with a yield of 85%.
   A technique of electrolysis of water which significantly reduces the maintenance associated with tailings electrodes into the liquid.
   An innovative release of gas bubbles from the walls of the electrodes by the introduction of a solution derived from vortex called “technique of walled jet stream water.”
   A real solution to reduce emissions of polluting gases and particles associated with the operation of internal combustion engines.
   A low-cost system that saves energy and fuel in the sectors of transport and housing.
   A system designed with a small footprint for easy installation and integration into multiple environments.
   An innovative system that allows a dialogue and an intelligent management of its own parameters.
   An innovative electricity assistance using hydrogen fuel cell with zero emission of CO2 and significant reduction of pollutant gases, namely: CO, CO2, NOx, SO, etc.
   An innovative system of gas production with multiple security levels (electrical, electronic, mechanical and hydraulic).

Consequently, we can summarize the advantages of this invention in the transportation industries and electricity generation with key sectors such as transport with the Automobile, Trucks, Boats, Planes, and with heating Habitats and electricity for individual homes, offices, industrial premises, hotels not to mention the OEM market sectors in various industries for Incinerators, Torches, Generator, shipyard buildings, etc.

Another advantage of the present invention is to operate internal combustion engines in any hydrogen system with a simple switch between its original modes ‘fuel” and hydrogen. Simply, a change of lubricant is required (for example; use of a synthetic lubricant,).

Similarly, the hydrogen fuel cell based on the same nanotechnology, described herein, can consider using this invention in hybrids or electric cars.

Another advantage of this invention is the use of electricity from hydrogen fuel cell with a configuration that ensures a nomadic use with remarkable portability and flexibility.

One obvious consequence of the present invention is that: as hydrogen and or oxygen produced by the super electrolyzer are not consumed, the loss is limited to the amount of hydrogen or oxygen related mainly to leaks and mechanics of implementation. We can therefore recover the initial water out of hydrogen fuel cell in the circuit and refer to the main tank from electrolysis, after recovering energy as ON-DEMAND electricity. H and 0 gases remain in the closed circuit of the present invention. There is only a change of state at each step.

### DESCRIPTION OF THE INVENTION

The invention relates to a generator of energy in assistance or sole source with a high yield of on-demand gas and a simultaneous production to the energy needs.

Understanding of the present invention is simplified by its structure. It is a modular design that allows different configurations, each making different products, suitable for a given use, depending on the combinations used and according to the need and scope. Well present the various aspects of this invention in the details for each important element of basic knowledge:

Matrix

a. Interconnections and interface modules

b. Control electronics and controls

c. Power interface module

d. Interfaces Screen Monitor

e. Main tank and pump

f. Tank and pump ion concentration

g. Bubbler (s)

h. Filtering system and associated circuits

i. Buffer stage

j. Sub Interface

Modules

k. Interconnections and interfaces with the matrix and/or other modules.

l. Electronics module card,

m. Nano metal electrodes,

n. Electrolysis chamber.

Monitoring and Control System of Command

o. Display message

p. Parameterization

q. Self-tests

r. Communication interfaces.

Output Use

s. Gas mixture or separated

t. Current

u. Voltage

The simplified principle of operation of hydrogen production to demand in this invention as described by the figures (FIG.6) for stationary systems with a variant for embedded systems in a vehicle, for example (FIG. 6B).

This is a whole electrolyzer comprising:
A matrix generator has an electronic command and control
One or more modules electrolysis
Part converter
Part of user output

Matrix electrolyzer consists of several distinct parts:
Tank electrolyte, ionic strength and buffer tank
Electronic control and interface
Indicators mounting
Main pump systems with variable flow pump, pump and ionic concentration of the buffer stage.
Non-return valves
Bubblers
Dryer (or drainage system) of gas
Filtering system for the electrolyte,
Parts of cooling.
Hydrogen Fuel Cells
Releases secure gas
Output Power

The main reservoir of the matrix contains electrolyte of all the modules. For the generator which is the subject of this invention, we always determine a minimum volume that meets the constraint related to the power required and available space (case of mobile applications for example).

For our explanation we will consider that the required power has to respond to autonomy of 34 hours with a volume of 150 liters of gas per hour.

The volume calculation for a system composed of a matrix with a full tank of electrolyte of three (3) liters and at least one module with one (1) liter capacity gives then a full size of the matrix 22 cm in length (L) over 12 cm thick (P) and 20 cm (H). Likewise, similarly for the module is obtained with 5.5 cm in length (L) 11.5 cm thick (P) and 19.5 cm (H).

Taking into account the volume of a single module connected to the matrix, the production will be of 1285 liters of gas per hour, or 20 lit/min (based on a yield of 85%, corresponding to about 4 hours of operation at full regime). The inventors have noticed that 200 lit/hour of HHO gas was sufficient for the enrichment of GEH internal combustion engines (up to 4 liters of displacement). For this quantity the autonomy of the system is to reach 25 hours.

The production of hydrogen is controlled by the electronic control board consisting of:
CPU, memory, program interfaces and electronic input and output.
Components for measuring current and voltage converters with.
Sensors and system security and control of polarity.
Control panel and connectors.
Interchange and energy converter.
Temperature sensors.
Ignition air call.
Various sensors and controllers.
Out of gas.

In the present invention, the “checkpoint” is characterized by the couple “Control-Command”:
1—Control: Typically an entry from a sensor to the electronic control unit.
2—Command: Mainly “output command from the control electronics to the destination part or device usually related to an action or sensor or display.”
3—The mechanical or actuator/regulator control himself managing a flow/flux.

The essential functions of control are:
Work conditions of the device asking for energy (oil pressure sensor in the case of a vehicle for example).
Checking the water level in the main tank.
Level control of the ionic concentration in the reservoir.
Level controlling of the buffer reservoir.
Control of level in bubblers.
Temperature control of the electrolyte of the reservoir.
Temperature control of the electrolyzer.
Temperature control in the cooling system.
Control level of pressure in the electrolyte reservoir.
Control level of pressure in the electrolysis module.
Control of the ion concentration in the main tank.
Control of voltage converter, current changes polarity and frequency.
Control of current in the hydrogen fuel cell.
Control of mixing pumps and cooling system.
Control and measuring system (for use in internal combustion engines, this task is performed continuously by the electronic control system while in the case of electricity, the system does not adjust the need for a cell conversion and storage is always charged).

To better understand this invention, we describe the production of an important element which is hydrogen.

At power up of the system, the electronic control performs a self test and verification of security settings; the electrodes in the electrolysis module are powered.

The simultaneous production needs and the flow of hydrogen is controlled by:
Current applied to the electrodes.
Pulse frequency determining the time of electrolysis
Control of Power “A” or more electrolysis chambers.
Buffer stage device.
Surface of the electrode.
Level of electrolyte.

Note that in the particular case of production of HHO stochiometric mixture, the polarity change function of the system can be activated.

The electronic control unit continuously determines the flow rate of hydrogen by measuring the volume of gas produced by the flow meters installed at the outlet of the drainage system of gas and informs the user via screen display monitor. All important information can be viewed on the screen of the same monitor. This information is illustrated in FIGS. 7 and 9.

The electrolysis system module is composed of pipes that supplies and returns the pressurized electrolysis as well as all interconnection and gas return circuit. The connector modules provides the arrival and return of specific signals of the module itself and of its power as shown in FIG. 3D.

Each module also provides a free passage of information from adjacent modules through an electronic card installed individually in the slot provided for this purpose. The electrolysis chamber is composed of a minimum of two (2) Nano nickel electrodes mounted “3D (three dimensional effect or Triple Nano Effect)”, in a fluidized bed electrolyte as shown in FIG. 12D which shows exponential increase of the gas production technique with a fluidized bed (fluidized bed design or “FBD”).

This technique involves the addition of some of the actual nanoparticles in the electrolyte. This third variable (third dimension Z with respect to X and Y axes defining the plane electrode) enhances the surface reaction by the fact that all suspended particles are added to the surface of the electrode in its third dimension.

Note that internal combustion engines used in transportation or in industry have the characteristics of producing greenhouse gas during their operations. The production of pollutant gases is increasing considerably when starting a cold engine.

The innovative solution provided by the inventors to solve this problem (when the invention is used in hydrogen assistance) is the use of information provided by the temperature sensor associated with an internal clock of the electronic control system. Indeed, one can easily determine the status of the engine when igniting (cold or hot engine) using a correspondence table between these two variables (Table configured to help reduce a product's use in areas or countries).

For example, a cold start at an ambient temperature of 10° C. requires a flow of hydrogen at the start more important than starting at an ambient temperature of 40° C.

Note that a decrease in the temperature of the combustion chamber reduces the nitrogen oxides (NOx).

An advantage of this invention is to separate hydrogen and oxygen from its production around the electrodes, which contributes significantly to the decreased production of NOx.

After starting the system, the electronic controls check at every instant the demand and adjust the flow of hydrogen by various techniques described in this invention. This production is based upon the need for gas with some additional production required for the servo functions (buffer stage device) that meets the case of acceleration for use in combustion engines at all time (servo feed-back).

An important point of the invention lies in the servo feedback system that controls the electrolysis with a flow of gas. At any given acceleration, the buffer chamber lowers the condensation cycle to meet the demand for any required temporary surplus of gas (for the combustion engine for example).

At each instant deceleration, the buffer chamber increases its “condensation cycle (unlike the hydrogen being produced in the reactor chamber before the order of decreasing gas is actually performed and stabilized in order to answer demand for temporary reduction of gas) to meet the demand by the internal combustion engine for example and that, before the system enters its normal cycle.

Indeed, the buffer stage responds effectively to requests for on demand (pick, stabilization, smoothing, or acceleration) of energy, and that absorbs at refusal (decrease, hollow surplus or deceleration) of energy. The “On Demand” produced Hydrogen responds to the simultaneous production of needs.

This advantage also overcomes the bearing to the time constant of the system caused by the inertia of the subset in the chain of production of gas by the electrolysis system. The volume of a buffer stage is directly dependent on the time constant of the electrolyzer.

Generally, in classical solutions; Hydrogen is provided by either the compressed hydrogen with the following implications:
Strengthening of the storage chamber,
Use a pump,
Increased consumption of the general assembly,
Management of change in pressure,

Or by solidification (metal hydride or nano-porous) with features including:
Volume with low pressure, therefore, less sensitive to fine tuning (careful management).
Instant Return of dissolved hydrogen (stored) in the body of materials, etc.
Absorption of surplus of hydrogen by the custom control electronics system.

All These Constraints are Resolved by the Buffer Stage as Part of This Invention.

Indeed, the requirement for simultaneous production is easily quantified by type of each application. For example, for use in hydrogen assistance in the transport sector on a 2-liter cylinder vehicle, the system is asked to respond to accelerations that are of the order from 5 to 10 seconds. This corresponds to a maximum volume of 250 mlit/s before the extra hydrogen of the electrolyzer is set at this capacity (about 3 seconds, the value of the constant time of the system). Similarly, during the deceleration phase, an absorption capacity of hydrogen production under way is to be managed.

So we need a storage equivalent of the same order (order of magnitude) as previously described for this phase, approximately 500 ml/s. Other events to control in these cases are the activation command of metal hydrides and their own time constant in each phase.

Note that a kg of hydrogen at normal pressure has a volume of 11 m3. As such, it may require a management of hydrogen pressure in the buffer stage. This makes it very difficult, if not impossible, to store in the state in embedded systems.
A major advantage of this invention is that the buffer stage uses no storage to fill all of these functions. Indeed, the electrolyzer produces separate hydrogen and oxygen.

As we have described, each gas is individually piped and its flow is individually controlled electronically. Understanding of the benefit is simplified by describing certain possibility of the electrolyzer:
An electrolyzer with a capacity of 1800 l/h of hydrogen is in the overproduction of 10% compared to its need for assistance is from 0 to 0.5 l/s, and will see a total production of about 0-50 ml/s max to manage.

So there is a surplus of hydrogen in the circuit to meet any demand in this period (or during the acceleration). Any unused surplus is immediately routed to the fuel cell provided with its tank conversion where oxygen is also sent in quantities necessary for production of H2O. This is pure water which is re-injected into the matrix's reservoir. This ingenious solution also allows controlling the ion concentration of the electrolysis.
Of course any deceleration or deny use of hydrogen already produced and waiting instantly increases the production process of the water. Any excess water is removed by a simple valve system output.

At any moment the workflow for each gas, allows instant response to requests in a point (function detailed in FIG. 5).

Indeed, in an application for assistance at the request of hydrogen for internal combustion engines, the need for hydrogen is a function of instantaneous speed, engine capacity and type of vehicle. The flow of hydrogen is then put to an initial value when setting up the system. This setting is usually done at the time of installation of the present invention.

These two (2) advantages of the present invention are important for safety and on demand production (at the request) of hydrogen. The flow is easily controlled and covers any gaps generated by inertia or a time constant of the system.

Note that:

1—In the case of HHO stoechiometric gas, the fuel cell (hydrogen cell) can be replaced by a cooling system. The condensation chamber takes water out of fuel cell (hydrogen cell) or re-condensation of excess gas.

2—The establishment of diaphragm 3B-4 (FIG. 3b) determines the separation of hydrogen and oxygen gases.

The innovative solution proposed in this invention will describe a SUPER EFFICIENT electrolyzer, greatly increasing the efficiency of electrolyzers. Indeed, among the types of existing electrolysis to generate hydrogen (acids and alkaline). Alkaline electrolysis is the most appropriate because it eliminates the need for expensive precious metals as a catalyst, and with a large area of Nano scale particles, the catalytic reaction is more efficient. For alkaline electrolysis, nickel is ideal because it is much cheaper than platinum and can easily be produced at the Nano scale. Nano-scale nickel also increases the area available for catalytic reaction that generates hydrogen, which increases efficiency and hydrogen production rates.

One advantage of this invention is its electrolysis chamber essentially characterized by:
its high efficiency (85%) of gas to the order of 1,285 lit/h,
its small footprint that is 5 cm long, 12 cm wide and 19 cm in height,
its ergonomics,
its robustness,
its ease of installation and integration in embedded version,
its modularity.
   It becomes also simpler to consider configurations that allow control of electrode surface exposed to the electrolysis reaction (control level or surface exposure).

The module consists of:

1—The electrolysis chamber,

2—A minimum of two (2) electrodes,
Anode
Cathode

3—An electrolyte solution for the realization of the chemical reaction.

4—Input/output electrolyte, gas outlet,

5—Interconnection with the power supply.

The innovative solution used for the base module produces an average of 1285 liters/hour (l/h) with the possibility of controlling the amount of gas required at a given time “t”. Indeed, because of the fluidized bed “FBD” electrolysis technology that allows for 3D reaction, and the Ni/Fe (Nickel/Ferrite) of very high surface area called “nano catalyst”. The fluidized bed can increase the electrode surface and thus reduce the current density of reaction between the fluidized bed and the other electrode.

Based upon a voltage of 1.59 volts and a current of 5 A/cm2, applied to the electrodes, we obtain a yield of 85%. That is around 1800 watts.

According to Faraday's law for a 1 kg of H2, we need 33,000 watts per hour, so a power of 1800 watts produces about 0.05 kg of H2. Under the normal pressure conditions and temperature, one mole of hydrogen has a volume of 24 liters of. Consequently the volume of corresponding H2 is 600 liters.

To address the problem of surface electrodes in an electrolyzer, we use nano nickel powders (mixture of particles of 1 to 10 or 5 to 20 nm, coated with nickel oxide with a thickness of 0.5 to 1.5 nm).

The Low cost's of necessary nano materials to increase (about 1000 times) the catalyst surface of the electrodes, produce hydrogen directly from water and electricity with higher efficiency and greater production rate of hydrogen and oxygen gases. In the present invention, this highly efficient system is mounted in a compact module and is easily mounted in the matrix in the case of on demand assistance.

Another aspect of this invention is a nano-porous carbon filament and method of formation for use in the manufacturing of electrodes used also in hydrogen fuel cells. A mesopore formed on the periphery of nano porous filamentous of carbon is a pore tunnel type that is formed in the direction of a hexagonal arrangement of carbon from the periphery to a fiber axis. Said nano-porous filamentous of carbon is produced by selective removal of carbon hexagonal plane forming the nano filamentary of carbon via gasification using a catalyst after high dispersion of Fe, Ni, Co, Pt, etc., whose size is between 2 and 30 nm on the surface of filamentous nano carbon. The mesopore type tunnel is formed radially through a process of nano drilling. The size of nano-porous carbon filament can be regulated depending on the size of the catalyst nano-drilling and nano drilling conditions.

According to methodologies explained in this application, we find that some materials produce a large metal surface. The reference electrodes are queues in Zinc or Nickel and the chemical solution is Eutectic KOH (33% aqueous). These new generations of electrodes, produce 75% more effective at low electrical currents while remaining reasonably efficient with stronger surface current.

The table below shows the effectiveness of nano metals based on a type of electrolysis.

| | Conversion Efficiency | Conversion |
|---|---|---|
| Electrode Type | (0.1 A/cm²) | Efficiency (1 A/cm²) |
| Nickel powder | 46% | 19% |
| Platinum Black | 67% | 42% |
| VH2 | 71% | 49% |
| MgH2 | 81% | 58% |

As described above, the perfect Nano conductors have high impedances. To take into account more impurities present in the environment, we introduced Dn as transmission coefficients associated with the nth mode of propagation and we obtain G=Σ n=1 Dn 2 e²/h

Experimentally, we measure this resistance in a two-dimensional electron gas. To create impurities in the gas, we put a grid on the surface of the semiconductor, about 100 nm from the electron gas. A voltage applied to the grids used to constrain the gas and creates a barrier (by presence of an electrostatic barrier). The measure shows the plateau, linked to the apparition of a new mode of propagation in the device.

During this experimentation, we have also noted that there is more than 80% efficiency with porous nickel electrodes. This means that the use of Nano scale materials provides a horizon for the profitable production of hydrogen from water.

Studies in the United States, the specialized organization (Quantum Nano) show that a catalyst made using metal based Nano composites in an electrolysis reactor fluidized bed allows for the reaction in 3D (catalysis in a fluidized bed reactor or Catalysts in a Fluidized Bed Reactor “FBR”) that exceeds a rate of 5 Amps/Cm2 provides an efficiency of 93%. This is equivalent to 2 gge/hr/m2 (gasoline equivalent gallon of /hr/square meter) or 21 NM3/hr/m2 (Normal cubic meters per square meter) and 42 kWh/kgH2.

Note that other techniques such as membrane electrode used to produce hydrogen from water using heat (simultaneously hydrogen and oxygen in stoechiometric amounts). The heat source of the device described is the burning of a hydrocarbon using the porous burner technology. However, this device can be modified so as to exploit other sources of heat, including solar.

The recent availability of Nano metals on the market allows us to design a new set of electrodes made of Nano elements. The problem to address was the surface of the electrolysis.

Indeed, nickel 1 gr=0.6 cm, area of 1.12 cm² and 1 g Nano nickel 10 nm, represents an area of 67 m², which corresponds to 42 kWh/kg. So there is an exponential relationship of increasing the surface produces a jump to 87% efficiency (energy efficiency) and promises 93%.

Note that this technique can produce electrodes with Nano scale materials. There is an element to nano scales based materials or carbon composites or nano scale tubes, where such materials including nano metals from 1 to 50 nm or carbon nanotubes, generally called the nano components. On the surface of each is deposited a substantially continuous film of silicon nanoparticles (in the case of nanotubes, this film has a thickness ranging from 1 to 50 nm). Nano elements are arranged essentially parallel to each other and are secured by one end to a substrate and are arranged perpendicular (with of course, a substrate that is electrically conductive).

Process for preparing a material comprising Nano elements on the surface of each is deposited a substantially continuous film of nanoparticles of silicon, including a growth stage of Nano elements.

The present invention also an innovation in the electrodes used in the electrolysis chamber. Indeed, the use of new materials in the technique of electrolysis of compounded composed of carbon nanotubes and have particular advantages related to their electrical conductivity properties and increase their surface.

This gives a tube open at both ends, it remains to be close. For this we must introduce defects in the plane of curvature of grapheme, this is of pentagons.

These pentagons introduce a 112° bend in the chapter and the mathematical laws of Euler showing that a minimum of 12 pentagons to close the form (or 6 pentagons at each end of the tube) is needed. Studies show that the C60 molecule contains just twelve (12) pentagons and twenty (20) hexagone.

This represents the smallest possible fullerene. However, while a theoretical distribution of regular pentagons gives a hemispherical shape, there is usually a conical shape.

The nanotubes can have a very large length compared to their diameter (aspect ratio>1000). Subjected to an electric field, they will have a very strong peak effect (cf. principle of the lightning rod). With relatively low voltages can be generated at the tip of the huge electric fields is able to remove electrons from the matter and issue them to the outside. This is the field emission. This emission is extremely localized (at the end of the tube) and can therefore be used to send electrons on a specific spot.

Understanding of this part is simplified by the explanation of the manufacturing of an electrode-based pellets (cylindrical rods' compacted material), themselves based on nickel powder (micro nickel) tiny size (1 to 4 microns) mixed with 10% nano Nickel (1 to 10 nm). To achieve this we used the sintering technique (called sintering) (heating below the melting temperature) and compression of powdered nickel.

The electrode is connected to the cathode using a screen-based device such as platinum electrode and a diaphragm between hydrogen and oxygen based on “Cellophane (thin film composed of clear and hydrated cellulose). The flow of ions is at an angle of 90° to the surface of pellets and gas out of the same surface. So we need a liquid electrolyte in constant rotation to remove the gases produced to allow the electrodes to remain clear (Airjet removal or walled water).

FIG. 12B shows a net increase by a factor of 2000. FIGS. 12B and 12C also show that one can easily reach an efficiency of 85% with currents in the range of 3-300 mA/cm ². The conversion of gge/hr/m² employed (Galon of gasoline equivalent per hour per square electrode) equals 125 000 Btu of H2 (about 1 kg of H2). Note that this technique produces a volume of hydrogen 100 times larger than the graphite.

A major advantage of this invention is its control system and flow control of on demand hydrogen (or electricity) production. An example of the use of hydrogen production assistance is in a motor at variable speed or torque ratio defined by power horsepower.

The limits of variation of hydrogen production are generally defined by its electrolysis' capacity. In the case of our invention we will consider a production capacity of 240 liters per hour max. This rate can vary from zero (0) to 250 l/h. Elements controlling this flow are:
1—The intensity of current (DC) applied to the electrodes,
2—The variation in the duration of this intensity,
3—The temperature of the electrolysis solution (electrolyte).

One way of gas flow control is the control of current applied to the electrodes. Replacing current (DC) by short current pulse is therefore considered. Several Control current pulse methods are used:
System for controlling the duration and amplitude of current applied to the electrodes through the electrolyte. A pulsed system was developed by Naohiro SHIMIZU, with a range of voltages between 7.9 to 140V with duration of 300 ns and a frequency of 2-25 kHz. It demonstrates that the short pulse current produces an electric field that helps the production of hydrogen without reducing the efficiency of the electrolyzer for electrolysis is produced using the technique of limited rate of electron transfer, while in DC current (DC) occurs following the technique of limited distribution.
Control system of an electrical impulse produced by pulses of high voltage direct current (20 to 40 KV) at frequency of 10-15 kHz (other Internet sources give 50 MHz and less than 1 mA).
The inductance in series with the primer capacity absorbs the resonances within the molecule. These have the effect of breaking the covalent bonds between atoms of hydrogen and oxygen, using very little energy. Both the gas and remain separated until sufficient energy is available to recombine to form water again. These key points are taken to create tension at the particle.

In the case of transport, flow control for the enrichment of hydrogen (EHG) is essentially important in a cold start.

Indeed, the most important pollution is produced during the three (3) first mile at first startup or after a prolonged (when traveling in urban areas with high population density). The present invention provides a solution by the fact that the controller is capable of making a decision on the debit based on the following:

1—Check/verification (measure) from the current output rate of the module (its flow meter)

2—Check/verification of the suction (intake of air)

3—Measurement of temperature

A decision on the increase or decrease the amount of hydrogen is then taken by the control module unit that controls and regulates the production of hydrogen and the flow.

Optimizing of the hydrogen flow will be done using a configuration of the system during the parameter setup of the invention. This setup includes the entry of the engine type (petrol or diesel) and cylinders of the vehicle.

In the particular case of habitat, flow control support for electricity using hydrogen is so automated and is managed by the control electronics.

It is important to note that a configuration of this invention can in combination with an internal combustion engine, used as a standalone generator.

Fuel Cell (or Hydrogen Cell)

Recently, the technology of fuel cells and their performances have made great progress with respect of the heart of the cell device. The first demonstrations in the field of transport should see real market applications within five years. But many locks should be removed before marketing, especially on a large scale. Components of heart of the cell require the synthesis of new polymer membranes, catalysts using no more platinum, membranes-electrodes assemblies that allow a guaranteed reproducibility.

Finally, the management of the fluid, temperature and electronic control of the application are truly to be optimized. Knowing that direct combustion of hydrogen is to promote a pathway initially to increase the fuels combustion efficiency and with their flaws of CO2 production (livre blanc CNRS).

Nano metals provide an answer to some of these expectations. As described in our invention during the explanation of the case of electrolysis, the increased electrolysis surface area allows for greater ability to exchange ions. Indeed, the hydrogen comes in contact with the pellet in electrode's nano metal.

This hydrogen is oxidized to form H+ions and releases electrons. The membrane allows only H+ions to pass. The electrons leave the cell and go into the electrical circuit. On the other side of the cell, H+ions combine with electrons that have passed through the circuit to react with dioxygène O2 and thus form water.

It is an advantage of the present invention to use the gases produced to hydrogen fuel cells directly to the output of the buffer stage and:
Either to regulate the instantaneous flow of hydrogen,
Either to produce electricity to meet the needs voltage or current of a given application.

Note that with an efficiency of over 95% produced by the present invention and equipped with a hydrogen fuel cell with a footprint of 05×04×12 cm 3 (H×W×D) as described in FIG. 2A-13 (FIG. 2A) we can consider a direct use in combination with multi about this module to generate electricity.

| Hydrides | Percentage of hydride/hydrogen content (mass) |
|---|---|
| LaNi₅H_{6, 5} | 1.4% |
| ZnMn₂H₃,₆ | 1.8% |
| TiFeH₂ | 1.9% |
| Mg₂NiH₄ | 3.6% |
| VH₂ | 3.8% |
| MgH₂ | 7.6% |

Some features of this application are used to store gases in hydrides. Storage of small particle form of hydride (e.g. aluminum) hydrogenated frees gases that can quickly be used as batteries in electrical appliances or laptop.

The importance of energy consumption in homes/habitats is a hot topic and subject of present discussions. The CO2 emissions that come from it, drives the focus of research and thus it mobilizes an increasing number of researchers on ways of developing and reduction of dimensions of stationary models at various scales, on the understanding of human interaction on comfort scenarios involving immediate environment and finally on integration of new ideas, especially for the management and optimization of houses with renewable energy and geothermal energy. Indeed, residential and tertiary habitat is the biggest consumer of energy in France (46.6% of national consumption in 2002, while transportation represented 24.9%).

With a yield of 80%, power output is 80% of the input power 1800 watt/h recovered at the output of the electrolyzer and converted into electricity we get about 1500 w/h of power output.

Given that in general to produce 1 kWh of electricity from a hydrogen fuel cell, it requires an average volume of 800 liters of hydrogen per hour.

With one module connected, the electrolysis produces 1285 liters of HHO gas. Knowing that hydrogen occupies ⅓ of the volume, so its volume will be of 1285 l/3=428 liters/hour. In conclusion, to produce 1 kWh of electricity, we will have to connect 2 modules on the matrix as it will be 856 liters/hour (2×428 liters) of pure hydrogen.

An important benefit of this invention is the use of hydrogen fuel cells (note that hydrogen cell is often used to differentiate a fuel cell that uses H and 0; where as a fuel cell is using any fuel/hydrogen and air) in a modular structure with multiple uses and shares the same technology of nano metals in the transformation cycle “Water-Gas-Water” with an efficiency exceeding 85%.

Note that for use of this invention with electricity outlet, the output can be equipped with a voltage stabilizer (UPS) that avoids unstable voltages generated by the connection/disconnection of appliances (control power capacity can be used to balance the current call caused by on/off switching of any appliance).

The main reservoir contains distilled water to which is added automatically a concentrated ion solution. The tank structure responds to stress corrosion itself.

One or more cooling solutions of the system can be integrated throughout. We use in this invention, the two systems of electrolyte circulation pump and system derived from vortex we called Walled Water as shown in Figure FIG. 3C).

Other examples of possible solutions are:
a. Heat dissipation by heat exchange.
b. Using the system Pelletier.
c. Chilled wall system.
d. Cooler.
e. Circulation in the radiator structure.
f. Using the system of the vortex.

We must also cite other elements, more common of the present invention. These elements are:
1) Bubbler; It is a simple system generally composed of water or water-based alcoholic solution for purifying the gas, to block the return of any flames and to change the temperature of the flame (case torches) of gas by mixing water with alcohols.
2) Cup light (flash arrestor) is a simple system usually consists of a tube filled with steel wool and with clappers of no return at the ends.
3) Filter, is a cartridge filter that purifies the electrolyte during its reintroduction into the main tank. This filters out impurities and residue from the electrolysis.
   Regarding the maintenance of the system, control electronics indicates filter change (every 750 hours for example) and emptying of the solution and its maintenance after a specified period of operation (every 3000 hours for example).
   The ion concentration control system is carried out at regular intervals. At each time period (e.g. 10 hours of cumulative operation) the control system of the ion concentration triggers (e.g. 33% of ionic concentration for KOH).
   A sensor in the reservoir concentration measurement and the measurement signals to the processor.
   The processor then controls a pump connected to a reservoir of highly concentrated ionic solution of concentrated ionic pour into the main reservoir of the matrix.
   A second step-up (adjustment) is triggered after a complete cycle of rotation of electrolyte in the electrolysis modules for all possible additions of concentrated ion.
4) The electronic control board having only conventional functions well known, will be submitted only by the block diagram because of the evidence of his tasks
   Note that the control cycle of the ion concentration triggers also:
      At each emptying of the buffer stage predetermined increments (e.g. 50 ml)
      At each addition of water in the main tank.
   In addition, the use of nanostructured materials in the realization of the pellets electrode is not constrained in crystallographic property that prevents the degradation of the electrode.

The example is taken on an area of one square meter and as indicated, a normal join use of electrodes to nano electrodes have demonstrated physical abilities to produce high efficiency and high electric value. This is the phenomenon Nano Triple Effect (3D nano Effect or Nano in 3 Dimensions). The results illustrated in the present invention shows that the efficiency of hydrogen production is multiplied by seven (7) and efficiency remained around 85%. Such results would let us consider mass production for the replacement of fuel by hydrogen in most applications.

Note that the use of nanomaterial composed of nickel and cobalt could replace partially or entirely the platinum catalysts in a variety of applications involving batteries and fuel cells (for example, if one replaces all platinum that is located on the cathode (7.7 micrograms [μg] per square centimeter [cm2]) by nickel cobalt could reduce costs by 90%, compared to those of pure platinum, but the yield would decrease 27%. In contrast, if we replace half of the platinum, costs still fall by 43% and it only loses 10% in terms of performance.

### BRIEF DESCRIPTION OF FIGURES

FIG. 1 shows the assembly of the Matrix and its modules and their interconnections electrolysis for producing hydrogen on demand for assistance in the present invention.

FIGS. 2A and 2B respectively represent the matrix sole without its electrolyzer module (2A) and details of the buffer stage and the return compartment (2B).

FIGS. 3A and 3B show respectively the “electrolyzer module with its connections “inputs and outputs” (3A) and details of the electrodes with pellets of nano metal mounted in the electrolysis chamber (3B) as presented herein.

FIGS. 3C and 3D show respectively the principle of water-walled (3C) and the control electronics and interconnection of each individual module (3D).

FIGS. 4A and 4B respectively show the assembly and installation of the system in vehicle (4A) and the position of the display monitor (4B).

FIG. 5 shows the principle of assistance for the production of electricity at home with the use of a hydrogen generator and a variant of the same principle, generating HHO mixture of the present invention.

FIGS. 6A and 6B respectively show the basic principle of the hydrogen electrolyzer assistance (6A) and a variant for the production of HHO mixture (6B) of the present invention.

FIG. 7 shows the block diagram of the system controls of the present invention.

FIG. 8 shows the block diagram of the control electronics of the present invention.

FIGS. 9A, 9B and 9C represent the Processing of data through a normal (9A) in cold start cycle (9B) and acceleration and deceleration cycle (9C) for use in the sector transport of the present invention.

FIG. 10 shows the Water Gas Water transformation cycle used in the principle of this invention.

FIG. 11 shows the principle of a hydrogen fuel cell with high efficiency based on the principle of nano-elements.

FIGS. 12A and 12B respectively show the efficiency rate of the different metals constituting the electrodes of the electrolyzer (12A), the production rate of hydrogen electrodes fabricated with metal pellets 3D nano mounted on platinum bar (12B) in connection with the present invention.

FIGS. 12C and 12D represent the electrodes efficiency data (curves in VoltAmper) of an electrolyzer using a super-efficient electrolysis reaction to produce hydrogen in a fluidized bed (12C) and volt-ampere curves of the cathode of a based catalyst powder (nano) nMnOx compared with cobalt nano (NCO) (12D) in connection with the present invention.

### DETAILED DESCRIPTION OF THE INVENTION WITH FIGURES

For a complete understanding of the present invention, we will detail all of the figures describing the various points of the system.

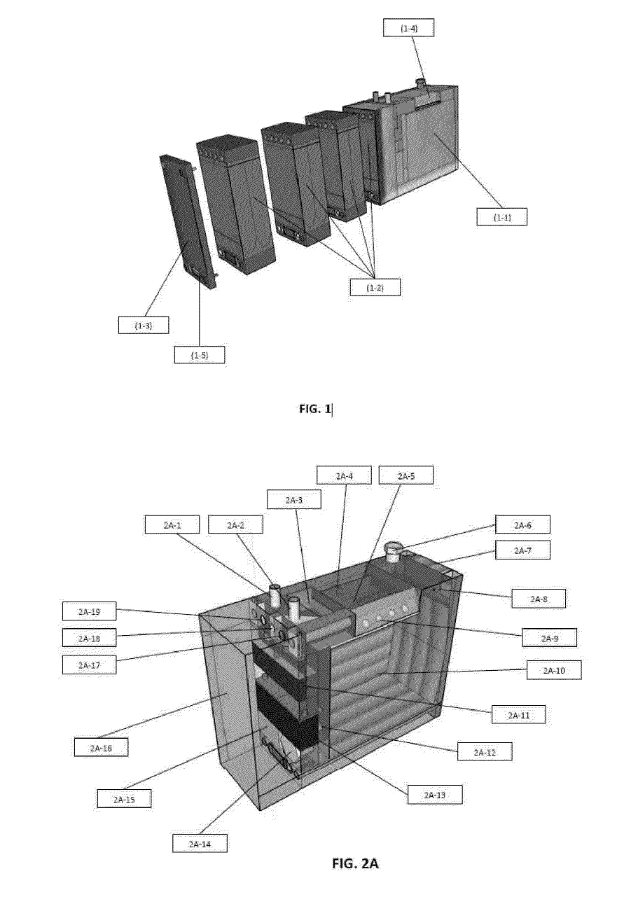

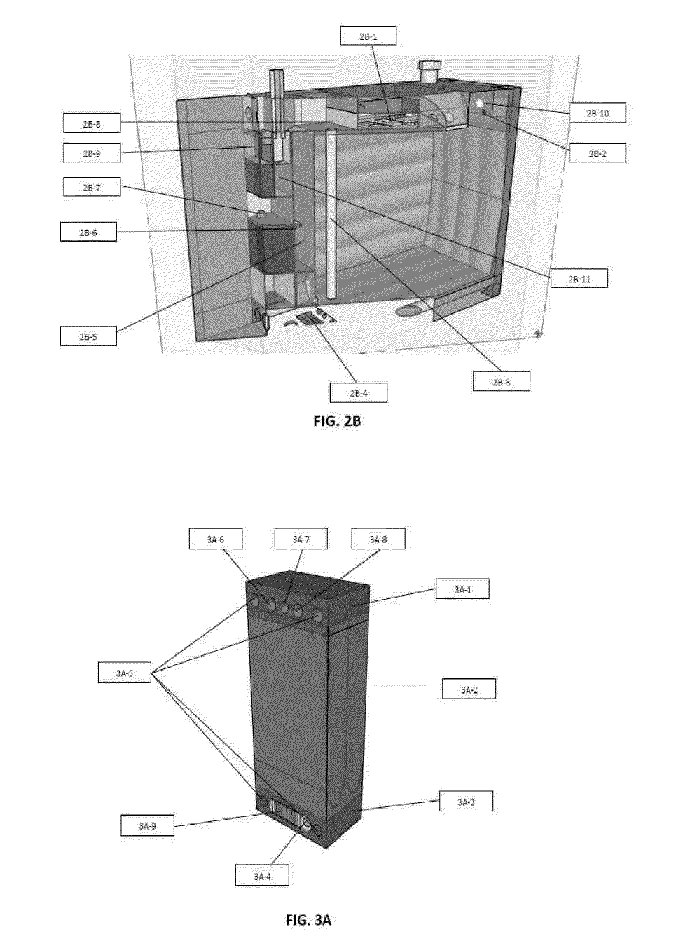

As shown in FIG. 1 through the modularity of the assembly is ensured by the ability of the invention to produce a quantity of energy or hydrogen variable (for example, which varies from 00 ml/s to 350 ml/s for hydrogen). This is made feasible through the electrolysis module presented by all three Figures that are fitted on the die of FIGS. 2. Matrix 1-1 (FIG. 1) also contains the stage containing the hydrogen fuel cell that provides electricity production.

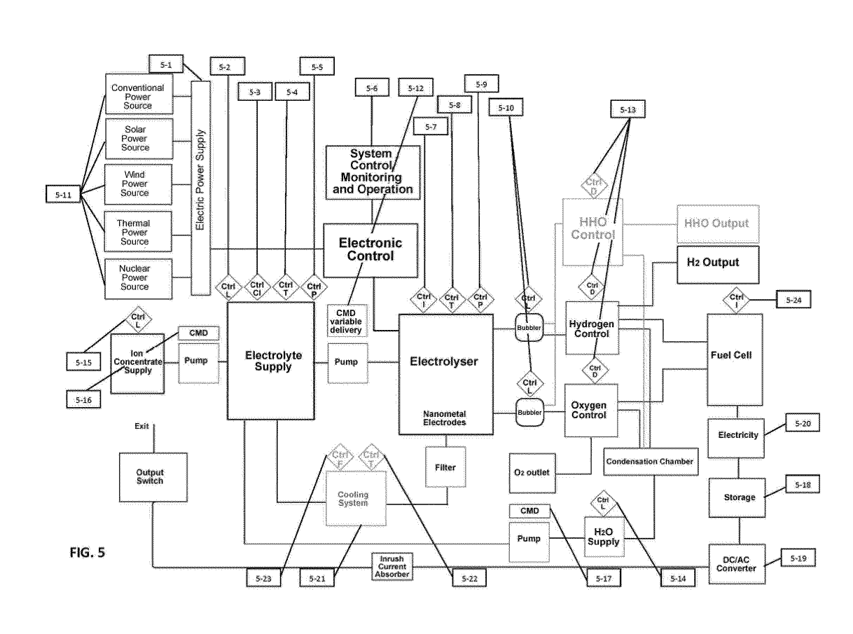

Matrix 1-1 (FIG. 1) consists of a card control electronics 2B-1 (FIG. 2b) indicators of connections between modules 2A-9 (FIG. 2A), the main reservoir 2A-10 (FIG. 2A), which is connected to a pump 2A-14 (FIG. 2A) supplying the variable flow modules electrolyte itself controlled by the control card with variable debit 5-12 (FIG. 5), topped a series of controller 5-2; 5-3; 5-4; 5-5 (FIG. 5) which manage the level of ionic strength, temperature and pressure. This matrix is provided with a secondary reservoir 2A-8 (FIG. 2A) that houses the cartridge 2A-7 (FIG. 2A) of concentrated ionic electrolyte for the entire system. The cartridge 2A-7 (FIG. 2A) is connected to a small pump 2B-10 (FIG. 2b), pouring the concentrate ion by channel 2B-2 (FIG. 2b) in the main tank 2A-10 (FIG. 2A).

Electrolysis modules 1-2 (FIG. 1) are mounted as follows: The first module is fixed in the housing 2A-16 (FIG. 2A) of the matrix 1-1 (FIG. 1). Then, following the flow/power/performance desired, other additional modules 1-2 (FIG. 1) can be nested by addition. The set ends with an end cap module 1-3 (FIG. 1) using the points of attachment 3A-5 (FIG. 1). Indicators 2A-9 (FIG. 2A) under translucent cache 1-4 (FIG. 1) inform the proper disclosure of all assembled together.

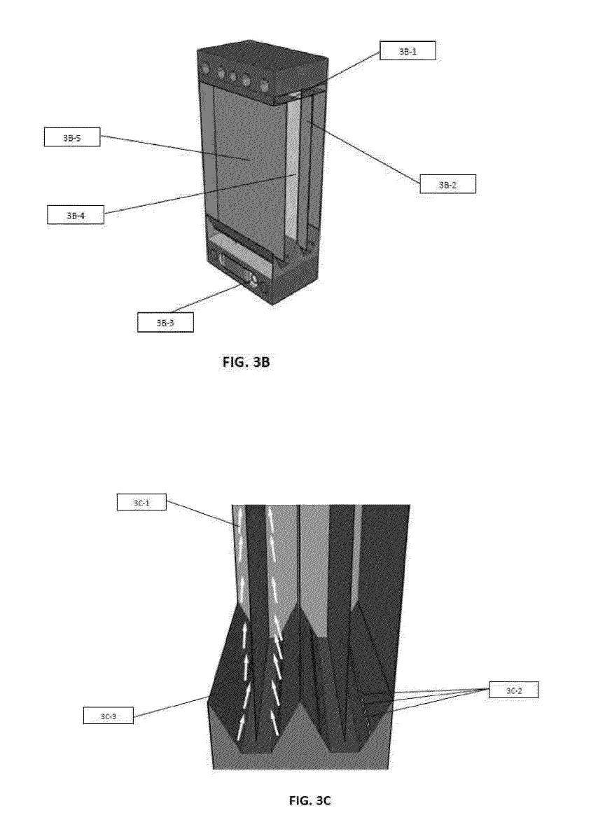

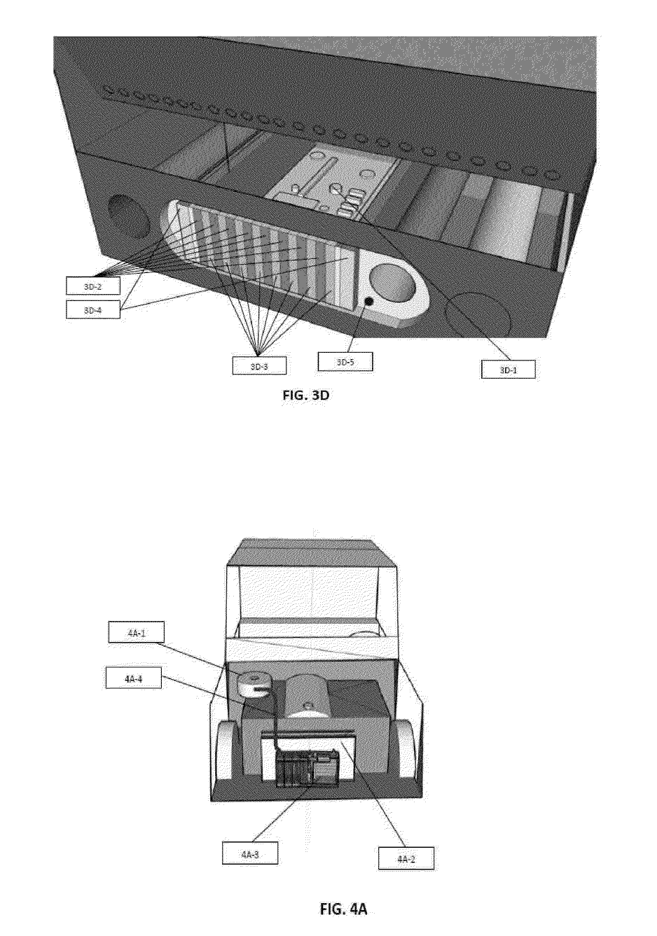

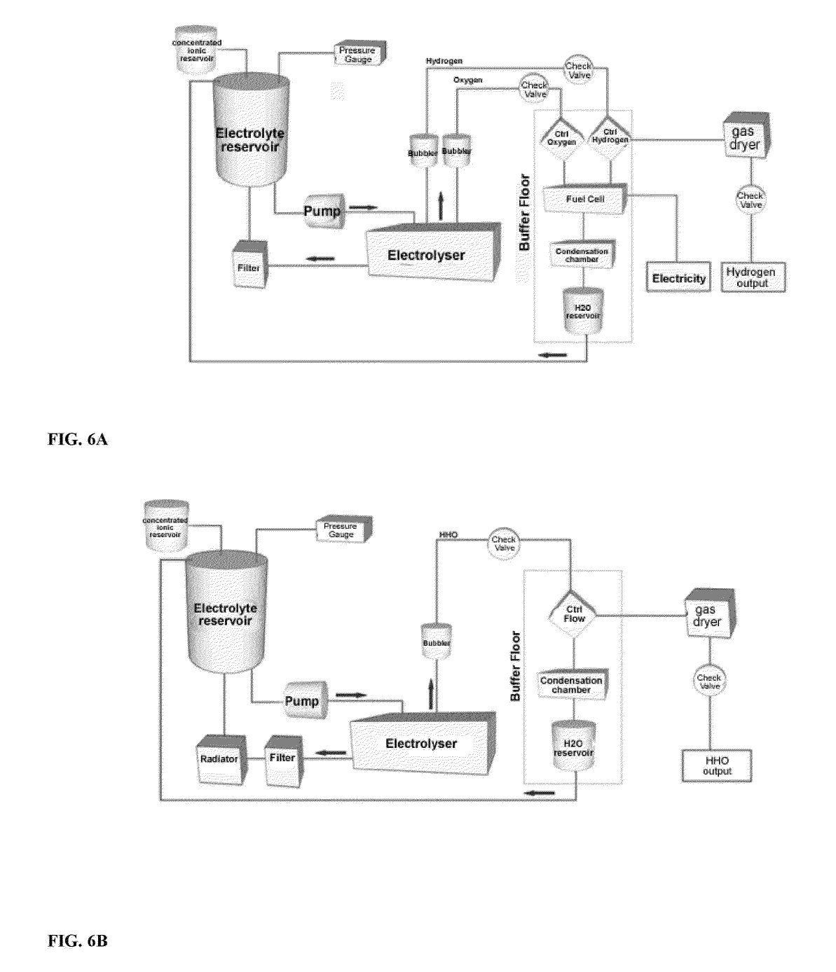

Each module electrolysis 1-2 (FIG. 1) is composed of 3 distinct compartments:
The arrival compartment 3A-3 (FIG. 3) with the connector block 3A-9 (FIG. 3) through which transit the power modules 1-2 (FIG. 1) through connectors 3D-4 (FIG. 3d), the 3D data-3 (FIG. 3d) and (FIG. 3d), the inlet pipe of the electrolyte 3A-4 (FIG. 3) with a valve Block/connection 3B-3 (FIG. 3b) and a switch to Inter connection 3D-5 (FIG. 3d) that returns a signal indicators 2A-9 (FIG. 2A). Inside this compartment is the electronic card control module 3D-1 (FIG. 3d).
The electrolysis chamber 3A-2 (FIG. 3) comprises electrodes composed of nano metal anode 3B-5 (FIG. 3b), cathode 3B-2 (FIG. 3b), a diaphragm (optional mounted as required by the desired gas type) 3B-4 (FIG. 3b) and the electrolyte membrane 3B-1 (FIG. 3b) (blocking liquid and letting the gas) and inlets electrolyte pressure 3C-2 (FIG. 3C) that generate the “walled water” 3C-1 (FIG. 3C). These holes are arranged by both sides of a frame in the shape of “V” 3C-3 (FIG. 3C) which houses the electrode concerned.
The outlet compartment 3A-1 (FIG. 3) includes driving 3A-7 (FIG. 3), back from the electrolyte to the main tank 2A-10 (FIG. 2A), the matrix 1-1, lines of hydrogen gas 3A-6 (FIG. 3) and oxygen 3A-8 converging towards the compartment receiving 2A-19 (FIG. 2A) and 2A-17 (FIG. 2A) of the matrix 1-1 (FIG. 1), which is more than the entrance (s) bubbler (s) 2B-9 (FIG. 2b) which function “Filter/Separation” known for its cleansing effect (or dam water and filtering on the return of gas).

We'll follow the path of the gas and its possible transformation in the present invention. When they finish bubblers 2B-9 (FIG. 2b) gases are directed to a drying chamber gas 2A-11 (FIG. 2A) and blocking the return of any open flames (better known under the name of Flash Blocking or lightning arrestor).

A portion of the gas drained out of this compartment is moving towards a hydrogen fuel cell 2A-13 (FIG. 2A) while the other party is referred her to release gases 2A-1 (FIG. 2A) and 2A-2 (FIG. 2). The steam generated by hydrogen fuel cells in this process is collected in a condensation chamber 2A-15 (FIG. 2A) before being sent into the buffer tank 2B-5 (FIG. 2b). Filling of the reservoir or in the indication of a level controller 2B-6 (FIG. 2b), another small pump 2A-12 (FIG. 2A) directs this water to the main tank 2A-10 (FIG. 2A). This advantage allows electricity 5-20 (FIG. 5) by the output 2B-7 (FIG. 2b), is sent to a storage unit 5-18 (FIG. 5) any (eg battery) or consumed in its DC or after processing through a DC-AC 5-19 (FIG. 5) in the habitat. The current output has a DC 5-25 (FIG. 5).

A variant of this invention provides a mixture of hydrogen and oxygen gas by removing the diaphragm 3B-4 (FIG. 3b), form stoichiometric (known as the HHO or Brown Gas to its inventor as the patent Invention No U.S. Pat. No. 4,081,656, and U.S. Pat. No. 4,014,777). This form of high-energy gas is produced with the aim of enriching internal combustion engines (GEH) or to use in the industry (cutting, welding or incineration system for example). Simply remove the diaphragm 3B-4 (FIG. 3b) and replace the floor with hydrogen fuel cell by a simple driving referrals to existing pipes. In this configuration, the production can be controlled to compensate for the excess functions of acceleration and deceleration possible for an application in the field of transport (cars for example).

On the electrolyte return electrolyte modules 1-2 (FIG. 1) is carried via line 2A-18 (FIG. 2A) before entering a compartment filter 2A-3 (FIG. 2A) where a filter 2B-8 (FIG. 2b) is installed, to be re-inject into the main tank 2A-10 (FIG. 2A) through line 2B-3 (FIG. 2b).

A particular configuration of constraints related to temperature parameters for obtaining a better performance would be to integrate a cooling system 5-21 (FIG. 5) mounted in the matrix (when replacing battery hydrogen 2A-13 (FIG. 2A) by a cooling system for example).

Matrix 1-1 is composed of a main PCB 2B-1 (FIG. 2b), under the cover 2A-5 (FIG. 2A) and is connect power source 5-1 (FIG. 5) and communicating with the monitor 5-6 (FIG. 5) through port 2A-4, an electronic map secondary 2B-4 (FIG. 2b) responsible for the interconnection of control between modules 1-2 (FIG. 1) and the control electronics of the matrix 2B-1 (FIG. 2b).

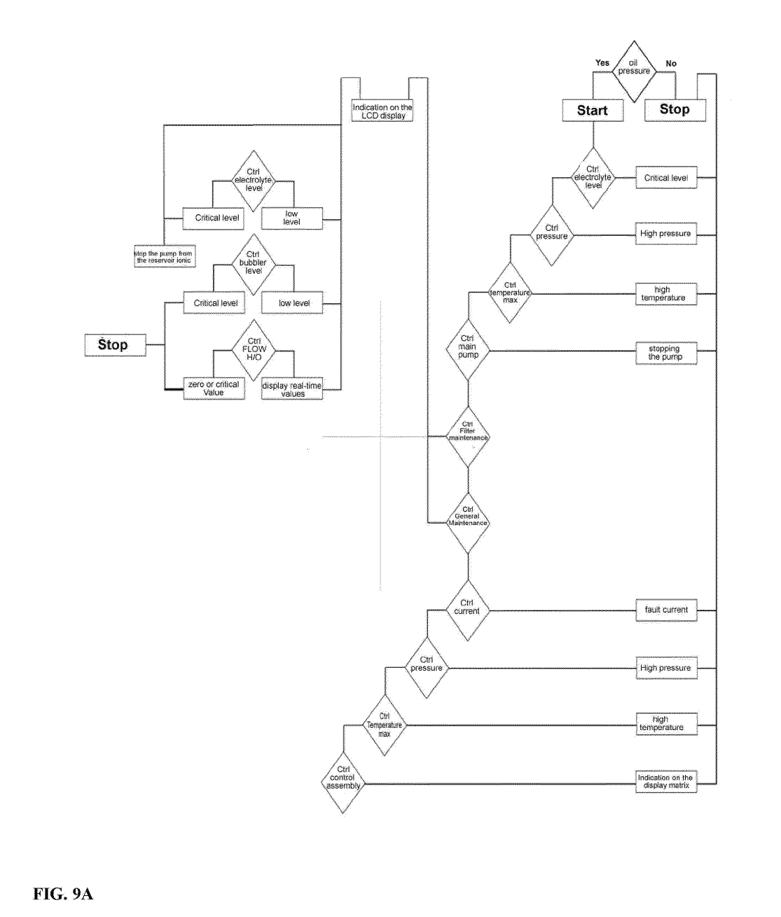

The location of the various controllers and sensors has been designated by a judicious choice of inventors to enable effective management of all system functionality. The most remarkable features of the invention are:
The power of the electrolyzer 5-1 (FIG. 5) may be provided by one or more energy sources 5-11 (FIG. 5). This power is in part a recovery of energy available, dependent on the environment and area of use (e.g. thermoelectric in the case of heat engines, hydrogen fuel cell 2A-13 (FIG. 2A) in the matrix, energy renewables such as wind, solar, photovoltaic 5-11 (FIG. 5). The current flow is controlled by the card 2B-1 (FIG. 2b).
The pair “Control, Command” system is composed of:
   Control, Automatic control or mechanical without the intervention of the control electronics:
      Pressure control valve and tank 2A-6 (FIG. 2A),
         Check oil pressure (FIG. 9),
      Control of contact (control assembly) modules inter-2A-9 (FIG. 2A),
      Control of pressure in the electrolysis chamber 3D-5 (FIG. 3d),
      Control of the thermal critical temperature by 1-5 (FIG. 1)
      Monitoring, control the decision of the Command electronics (FIG. 9A)
      Control, Command on the main tank 2A-10 (FIG. 2A) of the matrix 1-1:
         Control level 5-2 (FIG. 5) and control display or control system shutdown,
         Control ion concentration 5-3 (FIG. 5) and display control command or stop the pump 2B-10 (FIG. 2b),
         Temperature Control 5-4 (FIG. 5) and control and display system shutdown,
         Controlling Pressure 5-5 (FIG. 5) and control and display system shutdown,
         Control, control on the main pump 2A-14 (FIG. 2A) of the matrix 1-1:
         Control Operating 2A-14 (FIG. 2A) and Command and Control Display stopping the pump and system
         Flow Control and Electronic Control 5-12 (FIG. 5) flow follows the criteria of number of modules, temperature, flow demand,
Command, control on the module 1-2 (FIG. 1):
   Temperature Control 5-8 (FIG. 5) and Command and Control display system shutdown,
   Controlling Pressure 5-9 (FIG. 5) and command and control display system shutdown,
   Control Power 5-7 (FIG. 5) and Command and Control display system shutdown if critical value or anomalies,
Control, control on the (s) bubbler (s) 2B-9 (FIG. 2b):
   Control level 5-10 (FIG. 5) and control display so low and control system shutdown if critical value or zero,
Monitoring, control the flow of gas 2B-11 (FIG. 2b):
   Flow control 5-13 (FIG. 5) and Command and real-time display:
      if flow level is low or no shutdown command,
      if critical value or zero is reached after a complete cycle of increase in current control system shutdown,
      Otherwise proceed to adjust the servo speed.
Acceleration Servo case (FIG. 9C): This is an increase of gas flow with continuous monitoring of flow in light of its stabilization.
Servicing (servo feed-back mechanism) during deceleration (FIG. 9C): This is a decrease in gas flow with continuous monitoring of flow in light of its stabilization.
Servicing (servo feed-back mechanism) when starting from cold (FIG. 9B): This is an increase by a power conditioning and temperature control and timer to adjust the flow of gas with a Permanent control of the temperature in light of optimization of the flow.
Command, control on the reservoir 2B-5 (FIG. 2b) of the buffer stage:
   Control level 5-14 (FIG. 5) and Command 5-17 (FIG. 5) Pump 2A-12 (FIG. 2A) and launch a command cycle control of ion concentration 5-3 (FIG. 5).
Monitoring, control on the reservoir of the cartridge of the ion concentration 2A-7 (FIG. 2A):
   Control level 5-15 (FIG. 5) and Command 5-16 (FIG. 5) Pump 2B-10 (FIG. 2b).
   Monitoring, control the cooling system 5-21 (FIG. 5).
Temperature control 5-22 (FIG. 5) and control outbreak of fans and fan speed control.
Control of fans 5-23 (FIG. 5) and control forced activation.

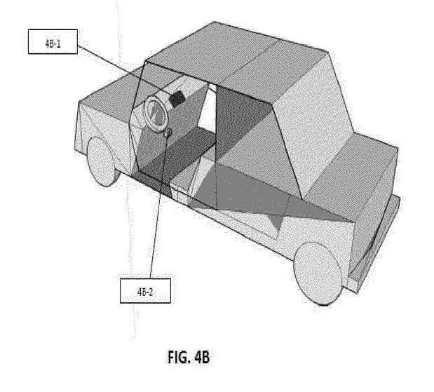

A variant of the present invention thus described can be mounted in the transport application with a very simple goal of on demand assistance in hydrogen, as described in (FIG. 4A) and (FIG. 4B). Indeed, the system 4A-3 (FIG. 4) pre-configured for a flow adapted to the needs of the application should preferably be installed at the front of the radiator 4A-2 (FIG. 4A) or in a ventilated location. Because of its small size, the system can be installed even in small vehicles (small cars in Europe). The gases pass through a line 4A-4 (FIG. 4A) to the air filter 4A-1 (FIG. 4A). The monitor display 4B-1 (FIG. 4B) provides the user interface or interface system installer.

A variant of this invention can connect to a connector provided by automobile manufacturers as standard nowadays: OBD (On Board Diagnostics or Diagnostic Embedded System) 4B-2 (FIG. 4B), allowing direct collection information (torque, power, real-time consumption, oxygen levels, etc. for example) to the system being of the present invention, enabling better optimization of its features.

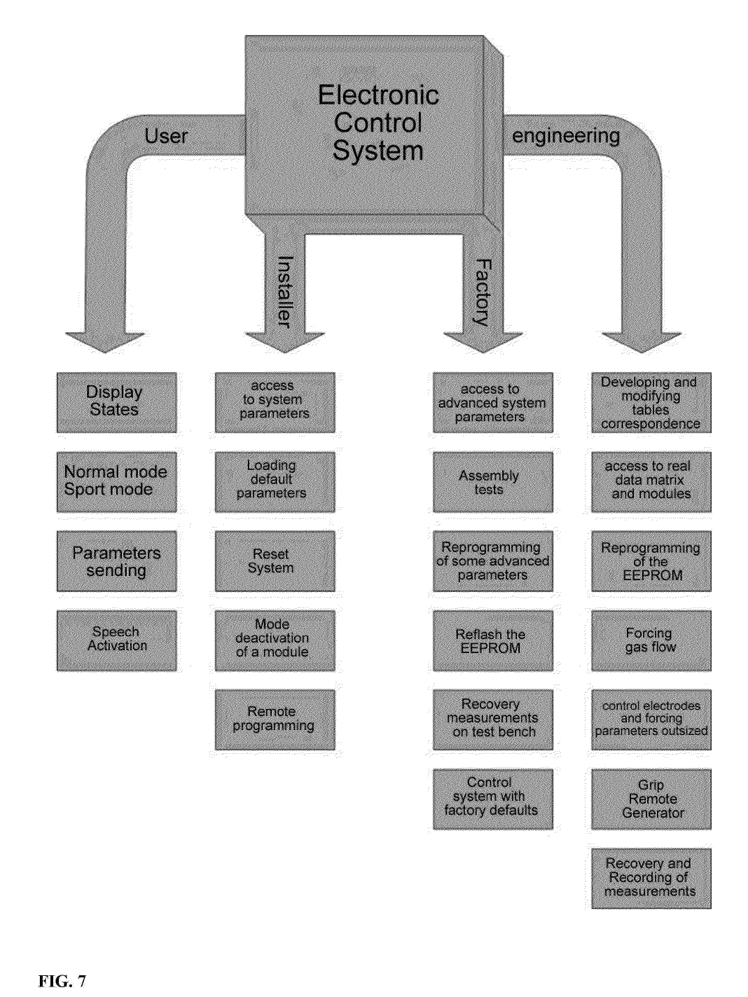

The electronic control system (FIG. 7) are designed to integrate the different aspects and different interfaces “man-machine” of this invention making it very simple and easy in use.

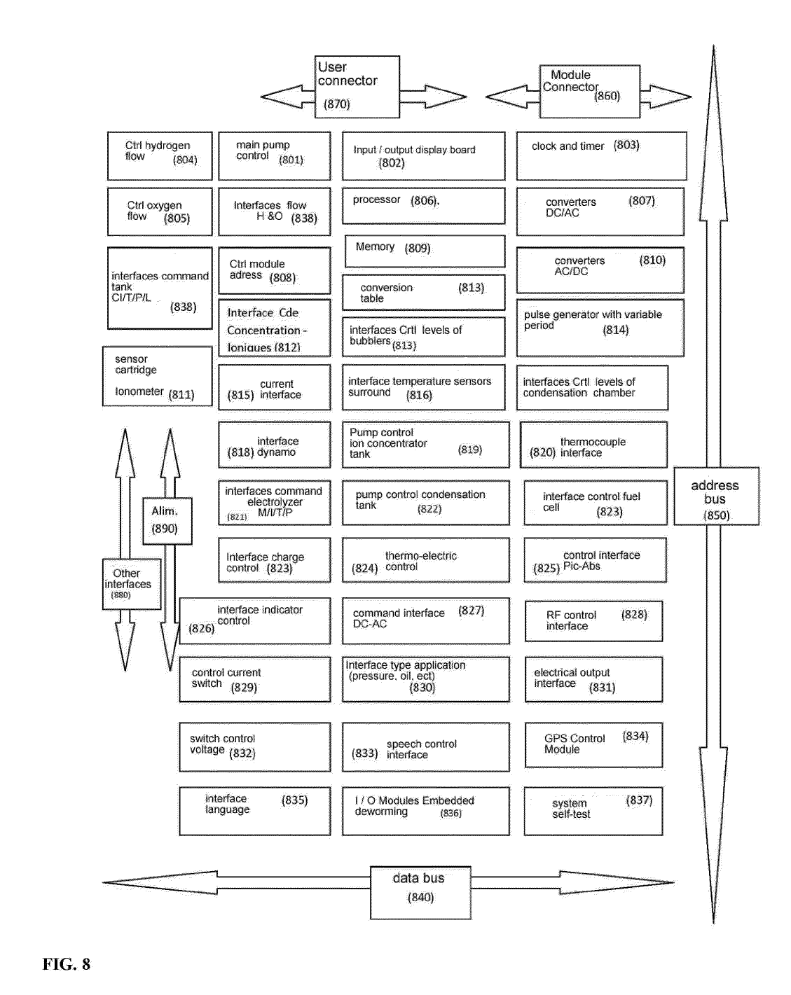

The block diagram of main components of the electronic control system (FIG. 8) highlights its flexibility, adds additional features and ensures a development with a remarkable adaptability as and when it entered the market World. In fact, the commands are executed by processor system structure which acknowledges the return receipt for performance, while ensuring its devices through sensors.

E-cards, E-boards and interconnections conveying vital information are protected by a shell (shield) against electric and electromagnetic fields.

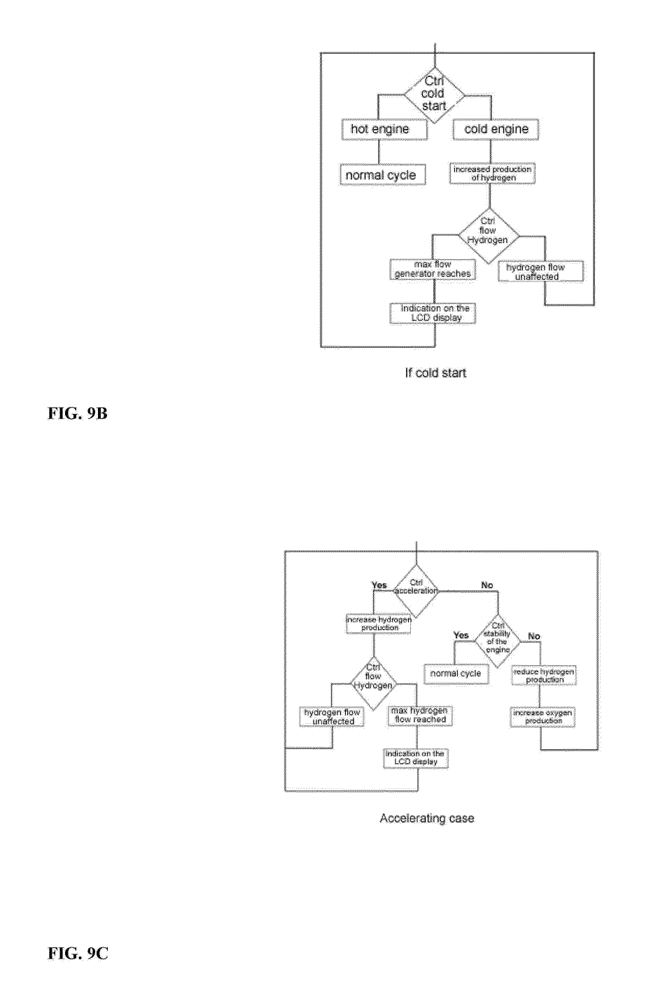

The cycle of transformation of water shown in FIG. 10 (Water-Gas-Water) illustrates a closed loop by the principle of obtaining energy by powering the system by producing renewable energy sources.

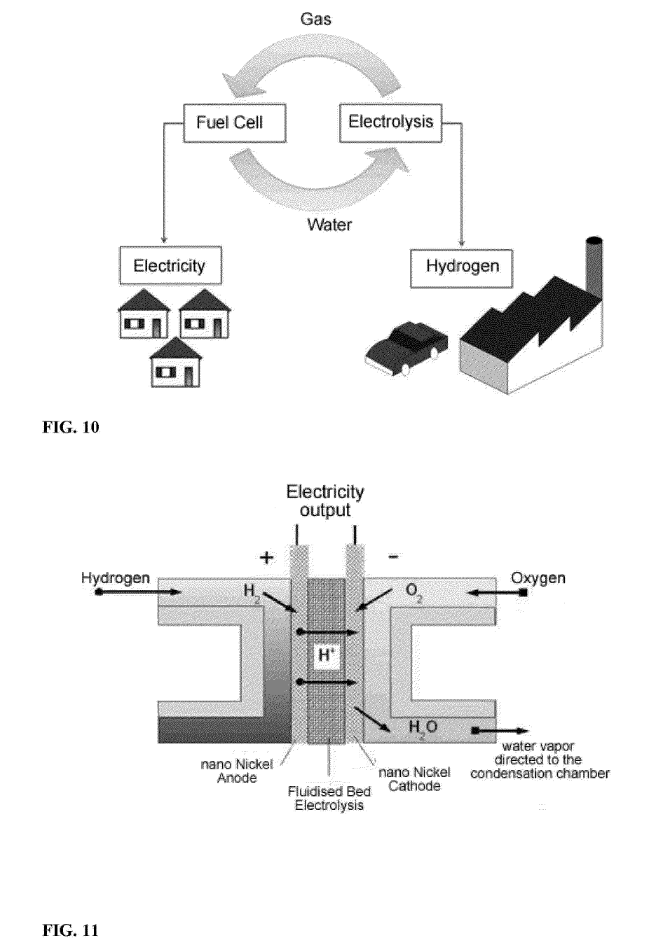

FIG. 11 illustrates the principle of a hydrogen fuel cell with high efficiency based on the use of nano materials as part of this invention.

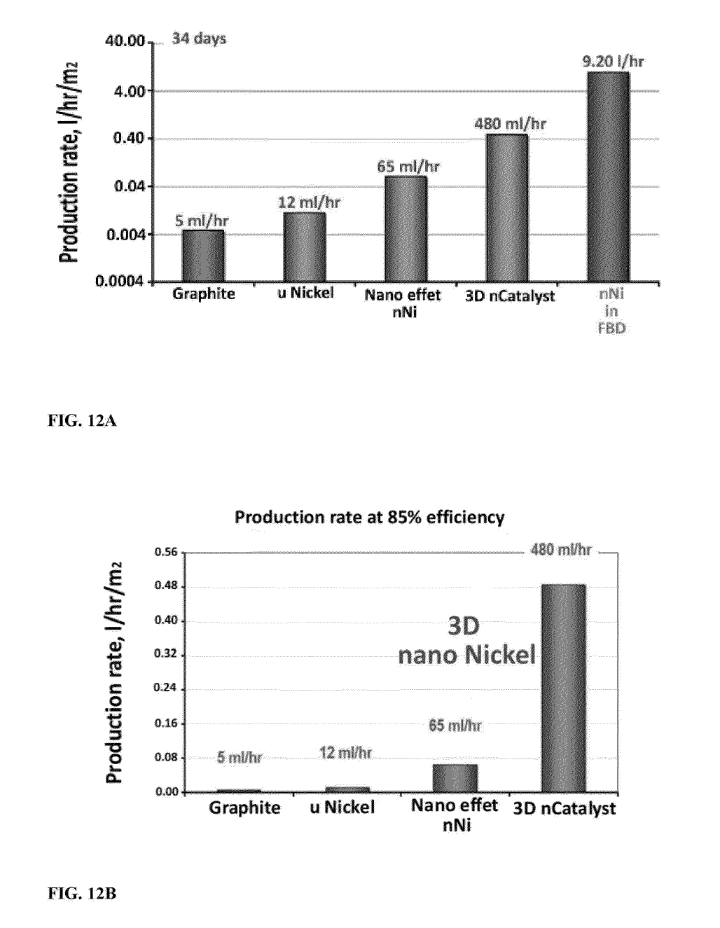

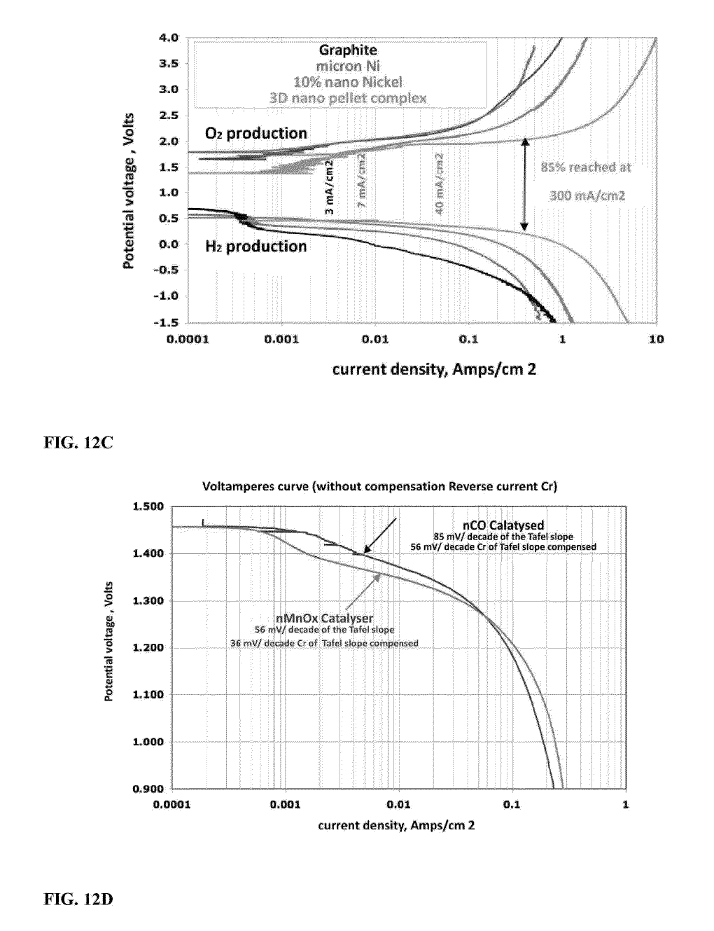

FIG. 12A shows the rate of effectiveness of different metals to produce the equivalent of 4 gallons of gas an area of one square meter (1 m²). For example, it takes 34 days for graphite electrodes, so that time is respectively 15 days for nickel electrodes in micro, Nano nickel for 3 days, 8 hours for 3D Nano nickel and 25 minutes for Nano nickel electrolysis with fluidized bed (FBD) reactor with 85% efficiency in relation to the present invention.

FIG. 12B compares the performance of electrodes made of Nano nickel with the triple effect of (or 3D Effect Nano in 3 Dimensions) Nano-catalysts to electrodes used in conjunction with normal Nano electrodes producing a high rate of hydrogen.

FIG. 12C compares the VA curves (using a voltammogram) of the anode (oxygen generator) and cathode (hydrogen generation). The difference between the lines set the voltage of the cell indicated by a double-headed arrow that shows 85% efficiency potential (1.743 V) is the efficiency of the electrolyzer super effective. This corresponds to around energy production with a rate of 42 kWh/kg.

FIG. 8 illustrates a block diagram of electronic control and the main components of the assembly.

This card-based intelligent control microprocessor, memory and in/output devices and command/controls allow it to carry out the various functions described in this invention. For obvious and simple reasons of understanding we will not develop the detail of wiring and inter connection of this illustration.

FIG. 12D shows a volt-ampere drawn (using a voltammogram) of the cathode made of a catalyst with the powder (nano) nMnOx compared with cobalt nano (NCO). NCO the cathode exhibits a larger exchange current (lo), and consequently a larger average value of Tafel CCV (Closed Circuit Voltage or discharge voltage Closed Circuit). Note that the cathode nMnOx shows a remarkably flat slope (greater catalysis) and a higher current density, making it a more powerful electrode.

It is important to note that the present invention is more clearly evidenced by the description of specific embodiments as described. Nevertheless, the object of the invention is not limited to these embodiments described because other embodiments of the invention are possible and can easily be achieved by extrapolation.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A system of energy production comprising;
at least one electrolysis chamber, electrodes, electrolyte, command-control means with at least one nano scales based materials or carbon compounds or tubes nano scale, such materials including nano metals from 1 to 50 nm or carbon nanotubes, called collectively the nano elements.

14. A system of energy production comprising;
at least one electrolysis chamber, electrodes, electrolyte, command-control means with on demand production and recycling means using the cycle of Water-Gas-Water.

15. In a system of energy production comprising a buffer stage to regulate the demand for energy or cogeneration. Said stage is equipped with inputs and outputs of gas and command-control and comprises at least one fuel cell wherein are in circulation, gas-type of hydrogen and oxygen, or hydrogen and air, or water vapor or methane, and wherein the adjustment of the flow of the “demand” is regulated by said buffer stage; equipped often with a component of gas or electricity storage.

16. In a system as described in claim No. 14, wherein, on the surface of each electrode is deposited a substantially continuous film of nanometric particles

17. In a system as described in claim No. 14 or 15, wherein the electrolysis chamber or the electrodes are modular to allow a variable flow of gases

18. In a system as described in claim No. 13 or 14, wherein the production of hydrogen and oxygen are a mixture or are separated.

19. In a system as described in claim No. 13, 14 or 15, wherein the flow of gases are obtained by activation and control of at least one function of; pulse time (0, current (I), frequency (F).

20. In a system as described in claim No. 13, 14 or 15, wherein the command-control means comprises an onboard electronic control, monitoring, optimization or intelligent interfaces.

21. In a system as described in claim No. 13, 14 or 15, wherein the hydrogen fuel cell is producing electrical energy.

22. In a system as described in claim No. 14 or 15, wherein, with or without a storage means, the system provides On Demand or simultaneous energy.

23. In a system as described at least according one of the claims No. 13 to 15, wherein, the system is capable of maintaining in a closed circuit, all or part of the gas produced by decomposition and reassembly of H2O or H and other molecule(s)
